(19) United States
(12) Patent Application Publication
(10) Pub. No.: US 2026/0187913 A1
(43) Pub. Date: Jul. 2, 2026

(54) INFORMATION PROCESSING APPARATUS, DATA STRUCTURE, AND PROGRAM

(71) Applicant: SONY SEMICONDUCTOR SOLUTIONS CORPORATION, KANAGAWA (JP)

(72) Inventors: MIKITA YASUDA, KANAGAWA (JP); NORIO YASUDA, KANAGAWA (JP); TSURAYUKI OISHI, KANAGAWA (JP)

(21) Appl. No.: 18/862,896

(22) PCT Filed: May 12, 2023
(86) PCT No.: PCT/JP2023/017857

§ 371 Date: Nov. 4, 2024

(30) Foreign Application Priority Data
May 12, 2022 (JP) 2022-078694

(51) Int. Cl. G06T 17/00; G06T 7/12; G06V 20/10

(52) U.S. Cl. CPC G06T 17/00; G06T 7/12; G06V 20/188

(57) ABSTRACT

An information processing apparatus according to the present technology includes a point cloud generation unit configured to generate point cloud data indicating a three-dimensional structure of a target area, on the basis of sensing data regarding the target area, a feature evaluation unit configured to evaluate a feature of a subject within the target area on the basis of a result of analysis of a captured image in which the target area is captured, an associating unit configured to associate evaluation information regarding the feature with the point cloud data, and an output processing unit configured to perform processing of outputting the point cloud data and the evaluation information associated with the point cloud data to an external apparatus.

### TECHNICAL FIELD

The present technology relates to an information processing apparatus configured to generate point cloud data indicating the three-dimensional structure of a target area, on the basis of sensing data regarding the target area, a data structure related to point cloud data, and a program for causing an apparatus configured to perform display control of point cloud data to execute the processing.

### BACKGROUND ART

For example, there is a technology for obtaining sensing data regarding a target area such as a construction site by, for example, aerial photography of the target area with use of a drone, and generating point cloud data indicating the three-dimensional structure of the target area, on the basis of the sensing data (see, for example, PTL 1 below).

PTL 1 also discloses a technology for removing objects other than the surface of the earth, such as construction equipment and buildings, as unnecessary objects.

### CITATION LIST

### Patent Literature

### PTL 1

Japanese Patent No. 6457159

### SUMMARY

### Technical Problem

Here, a system capable of adjusting the number of point clouds to be removed as unnecessary objects in response to user operations is considered. For example, evaluation values indicating the likelihood of being an unnecessary object are assigned to each point in point cloud data, and in response to a user specifying a threshold for the evaluation values by operations, points with evaluation values equal to or greater than the threshold are removed (that is, the number of point clouds to be extracted is adjusted). With this, it is possible to adjust the number of point clouds to be removed as unnecessary objects in response to user operations.

Further, a configuration in which the adjustment of the number of point clouds corresponding to unnecessary objects in response to user operations as described above is performed not by an apparatus configured to generate point cloud data but by a user terminal such as a tablet terminal used by the user is conceivable.

In that case, the user terminal receives a threshold specification operation as described above while displaying, to the user, point cloud data received from the apparatus configured to generate point cloud data. Then, in a case where a threshold is specified, the user terminal transmits the threshold to the side of the apparatus configured to generate point cloud data, to allow the apparatus to execute point cloud count adjustment based on the threshold, receives the point cloud data obtained after the count adjustment, and displays the point cloud data to the user. With this, the user can confirm the point cloud data with the number of point clouds adjusted according to the specified threshold, on a display screen of the user terminal.

However, in a case where the point cloud data display method as described above is employed, on the side of the apparatus configured to generate point cloud data, each time the user specifies a threshold, point cloud count adjustment based on the threshold and transmission of the point cloud data obtained after the count adjustment to the user terminal are performed. Thus, in the user terminal, the response speed at which the display of point cloud data according to the specified threshold is performed after the user's threshold specification operation decreases.

The present technology has been made in view of the above-mentioned circumstances, and it is an object thereof to improve, in a case where an external apparatus different from an apparatus configured to generate point cloud data performs display control of point cloud data based on user operations, the response speed at which display of point cloud data based on an operation performed by the user is performed after the user operation.

### Solution to Problem

An information processing apparatus according to the present technology includes a point cloud generation unit configured to generate point cloud data indicating a three-dimensional structure of a target area, on the basis of sensing data regarding the target area, a feature evaluation unit configured to evaluate a feature of a subject within the target area on the basis of a result of analysis of a captured image in which the target area is captured, an associating unit configured to associate evaluation information regarding the feature with the point cloud data, and an output processing unit configured to perform processing of outputting the point cloud data and the evaluation information associated with the point cloud data to an external apparatus.

With the above-mentioned configuration, in a case where the external apparatus is an apparatus configured to perform display control of point cloud data based on user operations, the external apparatus can perform display control of point cloud data based on user operations completely within the apparatus itself by using the feature evaluation information received together with the point cloud data.

Further, a data structure according to the present technology is a data structure of data to be output by an information processing apparatus to an external apparatus. The information processing apparatus includes a point cloud generation unit configured to generate point cloud data indicating a three-dimensional structure of a target area, on the basis of sensing data regarding the target area, a feature evaluation unit configured to evaluate a feature of a subject within the target area on the basis of a result of analysis of a captured image in which the target area is captured, and an associating unit configured to associate evaluation information regarding the feature with the point cloud data. The external apparatus is configured to perform display control of the point cloud data. The data structure includes the point cloud data and the evaluation information associated with the point cloud data. The external apparatus uses the data structure to perform display control of the point cloud data according to a user operation on the basis of the evaluation information received.

With this, the external apparatus configured to perform display control of point cloud data based on user operations can perform display control of point cloud data based on user operations completely within the apparatus itself by using the feature evaluation information received together with the point cloud data.

Further, a program according to the present technology is a program readable by a computer apparatus, for causing the computer apparatus to execute processing of receiving, from an information processing apparatus including a point cloud generation unit configured to generate point cloud data indicating a three-dimensional structure of a target area, on the basis of sensing data regarding the target area, a feature evaluation unit configured to evaluate a feature of a subject within the target area on the basis of a result of analysis of a captured image in which the target area is captured, and an associating unit configured to associate evaluation information regarding the feature with the point cloud data, the point cloud data and the evaluation information associated with the point cloud data, and performing display control of the point cloud data according to a user operation on the basis of the evaluation information.

With this, it is possible to achieve an apparatus that can perform display control of point cloud data based on user operations completely within the apparatus itself by using the feature evaluation information received together with the point cloud data from the information processing apparatus.

### BRIEF DESCRIPTION OF DRAWINGS

FIG. 1 is a diagram exemplifying the configuration overview of an information processing system as a first embodiment according to the present technology.

FIG. 2 depicts diagrams exemplifying a GUI related to display point cloud count adjustment in the embodiment.

FIG. 3 is an explanatory diagram of a current method.

FIG. 4 is an explanatory diagram of an example of a method as the embodiment.

FIG. 5 is a block diagram illustrating an internal configuration example of an information processing apparatus as the first embodiment.

FIG. 6 is a diagram illustrating a structure example of multiplexed data in the embodiment.

FIG. 7 is a block diagram illustrating an internal configuration example of a user terminal (external apparatus) in the embodiment.

FIG. 8 is a flowchart illustrating processing as the embodiment which is executed by the user terminal.

FIG. 9 is an explanatory diagram of another example related to feature evaluation.

FIG. 10 is an explanatory diagram of another example related to metadata superimposition.

FIG. 11 is a block diagram illustrating an internal configuration example of an information processing apparatus as a second embodiment.

FIG. 12 is a diagram illustrating a configuration example of an information processing system as a modified example.

### DESCRIPTION OF EMBODIMENTS

Now, with reference to the attached drawings, embodiments according to the present technology are described in the following order.
<1. First Embodiment>
(1-1. System Overview)
(1-2. Overviews of Current Method and Method of Embodiment)
(1-3. Information Processing Apparatus)
(1-4. User Terminal)
(1-5. Processing on User Terminal Side)
(1-6. Another Example Related to Feature Evaluation)
(1-7. Another Example Related to Metadata Superimposition)
2. Second Embodiment
<3. Modified Example>
<4. Summary of Embodiments>
<5. Present Technology>

### 1. First Embodiment

### (1-1. System Overview)

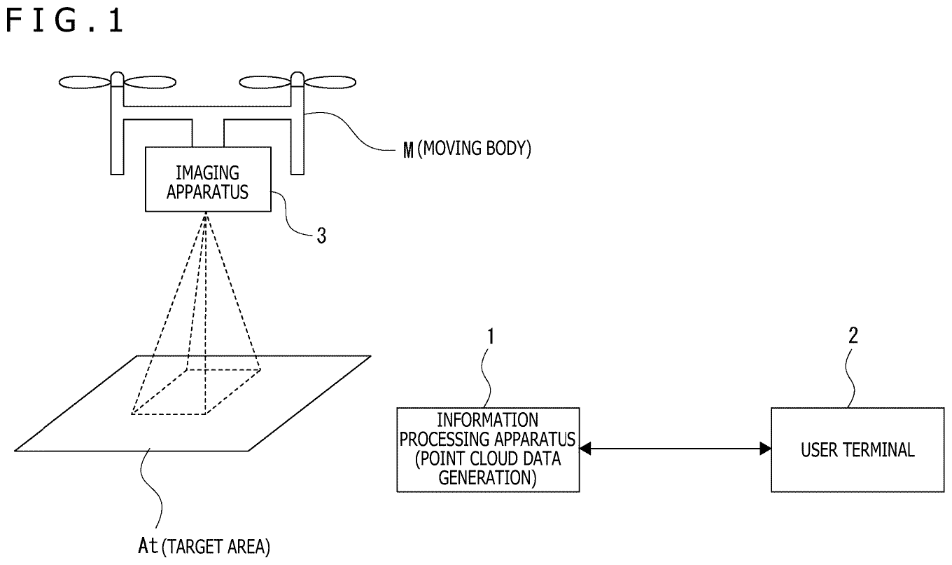

FIG. 1 is a diagram exemplifying the configuration overview of an information processing system as a first embodiment according to the present technology.

As illustrated in FIG. 1, the information processing system as the first embodiment includes an information processing apparatus 1, a user terminal 2, an imaging apparatus 3, and a moving body M.

The information processing apparatus 1 and the user terminal 2 are configured as computer apparatuses each including a CPU (Central Processing Unit), a ROM (Read Only Memory), a RAM (Random Access Memory), and the like.

The imaging apparatus 3 includes an image sensor of, for example, a CMOS (Complementary Metal Oxide Semiconductor) type or a CCD (Charge Coupled Device) type and obtains captured images in which subjects are captured. In this example, the imaging apparatus 3 is configured as an RGB camera including color filters for receiving R (red) light, B (blue) light, and G (green) light separately and configured to obtain color images as captured images on the basis of the received-light signals of the R light, the B light, and the G light.

The moving body M broadly means an object capable of moving with the imaging apparatus 3 mounted thereon. In this example, the moving body M is assumed to be a flying object such as a drone, an airplane, or a helicopter.

In the information processing system of the embodiment, while the moving body M having mounted thereon the imaging apparatus 3 is being moved over a target area At such as a construction site, for example, the imaging apparatus 3 is caused to image the target area At. At this time, the imaging by the imaging apparatus 3 is performed for each of multiple divided sections of the target area At. That is, multiple captured images in which sections different from each other of the target area At are captured are obtained as captured images of the target area At.

In the information processing apparatus 1, point cloud data indicating the three-dimensional structure of the target area At is generated on the basis of multiple captured images taken for each section of the target area At as described above.

Further, in the information processing apparatus 1, the features of subjects at multiple locations within the target area At are evaluated on the basis of multiple captured images taken for each section of the target area At as described above. Specifically, the information processing apparatus 1 in this example evaluates the degree of being an unnecessary object of subjects, as the evaluation of the features of the subjects.

The degree of being an unnecessary object here means an evaluation value indicating the likelihood of being an unnecessary object, which is an object other than the surface of the earth in the target area At.

The reason why objects other than the surface of the earth are treated as unnecessary objects is that the purpose in this example is to obtain point cloud data indicating the structure (three-dimensional shape) of the surface of the earth.

Note that, in this example, the degree of being an unnecessary object is calculated on the basis of the result of image recognition processing as semantic segmentation on captured images, details of which are described later.

The user terminal 2 is an apparatus that is different from the information processing apparatus 1 and that is assumed to be used by a user. In this example, the user terminal 2 is assumed to be a portable computer apparatus. Examples of the specific apparatus form of the user terminal 2 can include smartphones, tablet terminals, notebook personal computers, and the like. Alternatively, examples of the conceivable apparatus form of the user terminal 2 can also include smart glasses, head-mounted displays, and the like.

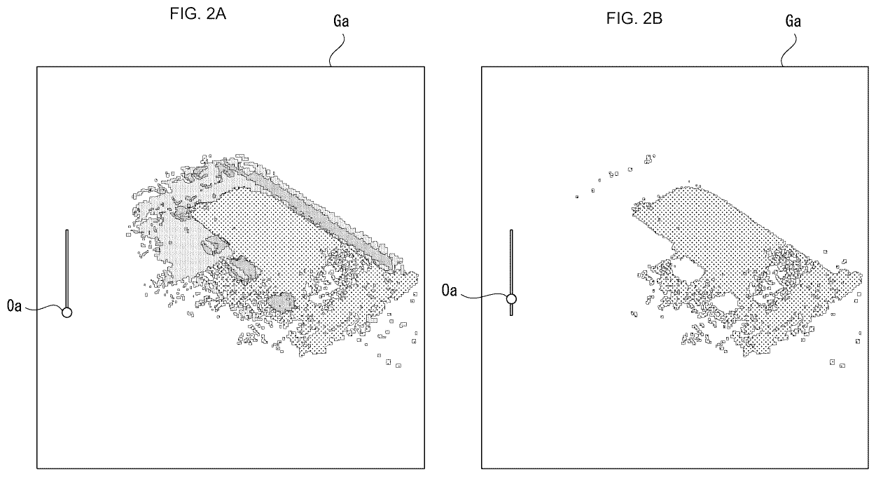

The user terminal 2 receives point cloud data from the information processing apparatus 1 and performs display control of the point cloud data. Specifically, as this display control, the user terminal 2 performs display point cloud count adjustment processing, as exemplified in FIG. 2, for example.

More specifically, the user terminal 2 performs the processing of displaying, to the user, a screen in which an image visualizing point cloud data and an adjustment operator Oa for adjusting a threshold for the degree of being an unnecessary object are displayed (hereinafter referred to as a “point cloud adjustment screen Ga”), as exemplified in FIG. 2A and FIG. 2B, for example. Then, in a case where a threshold for the degree of being an unnecessary object is specified by operations on the adjustment operator Oa, the user terminal 2 displays point cloud data obtained by removing, from the point cloud data, point clouds with the degree of being an unnecessary object equal to or greater than the specified threshold, on the point cloud adjustment screen Ga. The transition from FIG. 2A to FIG. 2B indicates an example in which the number of point clouds displayed on the point cloud adjustment screen Ga is reduced in response to a threshold reduction operation performed by the adjustment operator Oa.

### (Overviews of Current Method and Method of Embodiment)

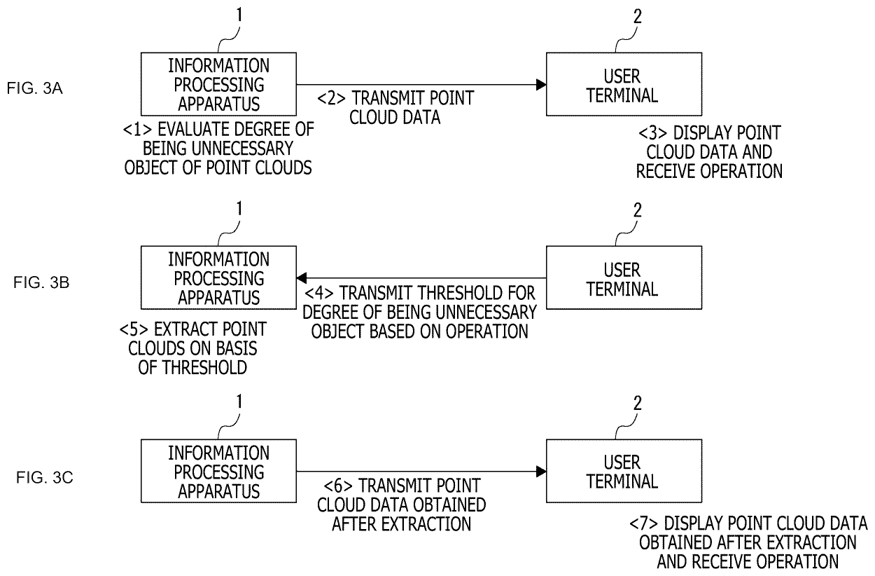

Here, as described above, in the present embodiment, it is assumed that the external apparatus (user terminal 2) different from the apparatus configured to generate point cloud data (information processing apparatus 1) performs display control of point cloud data based on user operations. As a method for the user terminal 2 to perform display control of point cloud data based on user operations in such a manner, currently, a method as illustrated in FIG. 3 is employed.

First, as indicated by <1> in FIG. 3A, the information processing apparatus 1 evaluates the degree of being an unnecessary object of point clouds. Then, the information processing apparatus 1 transmits the point cloud data to the user terminal 2, as indicated by <2>.

The user terminal 2 which has received the point cloud data displays the point cloud data and receives operations, as indicated by <3>. That is, the user terminal 2 displays the received point cloud data on the point cloud adjustment screen Ga and receives operations performed on the adjustment operator Oa (that is, receives the operation of specifying a threshold for the degree of being an unnecessary object).

In a case where a threshold is specified by user operations, the user terminal 2 transmits the threshold for the degree of being an unnecessary object based on the operations to the information processing apparatus 1, as indicated by <4> in FIG. 3B.

Then, the information processing apparatus 1 performs the processing of extracting point clouds on the basis of the threshold, as indicated by <5>. That is, the information processing apparatus 1 performs point cloud count adjustment to leave only point clouds with the degree of being an unnecessary object equal to or smaller than the threshold. In other words, the information processing apparatus 1 performs point cloud count adjustment to remove point clouds with the degree of being an unnecessary object greater than the threshold.

In response to the point cloud extraction in <5> described above, the information processing apparatus 1 transmits the point cloud data obtained after the extraction to the user terminal 2, as indicated by <6> in FIG. 3C.

Then, the user terminal 2 displays the point cloud data obtained after the extraction and receives operations, as indicated by <7>.

Although not illustrated, in a case where a new threshold is specified by operations, the user terminal 2 transmits the specified threshold to the information processing apparatus 1, and the information processing apparatus 1 extracts point clouds on the basis of the transmitted threshold and transmits the point clouds to the user terminal 2.

With the current method as described above, the information processing apparatus 1 configured to generate point cloud data performs, each time the user specifies a threshold, point cloud count adjustment based on the threshold and transmission of the point cloud data obtained after the count adjustment to the user terminal 2. Thus, in the user terminal 2, the response speed at which the display of point cloud data according to the specified threshold is performed after the user's threshold specification operation decreases.

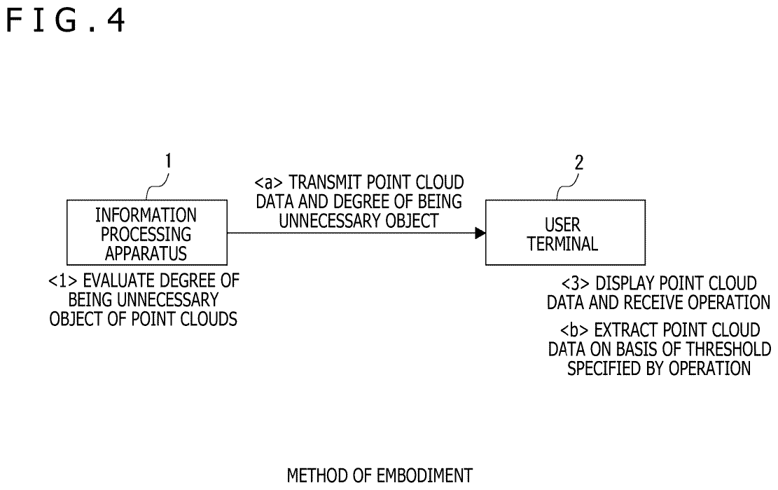

Thus, in the present embodiment, a method as illustrated in FIG. 4, for example, is employed.

That is, as illustrated in FIG. 4, the information processing apparatus 1 evaluates the degree of being an unnecessary object of point clouds (<1> in FIG. 4) and then transmits (outputs) the point cloud data and the degree of being an unnecessary object to the user terminal 2, as indicated by <a>.

The user terminal 2 which has received the point cloud data and the degree of being an unnecessary object first displays the point cloud data and receives operations as in <3> above. However, in a case where the operation of specifying a threshold for the degree of being an unnecessary object is made thereafter, the user terminal 2 performs processing of extracting point cloud data on the basis of the threshold specified by the operation, as indicated by <b>.

With the method as the embodiment as described above, the user terminal 2 can perform display control of point cloud data on the basis of operations completely within the apparatus itself by using the feature evaluation information received together with the point cloud data from the information processing apparatus 1. That is, in performing display control of point cloud data based on operations, there is no need to transmit a threshold specified by operations to the information processing apparatus 1 or to receive point cloud data with the number of point clouds adjusted on the information processing apparatus 1 side.

Thus, it is possible to improve the response speed at which display of point cloud data based on an operation performed by the user is performed after the user operation.

### (Information Processing Apparatus)

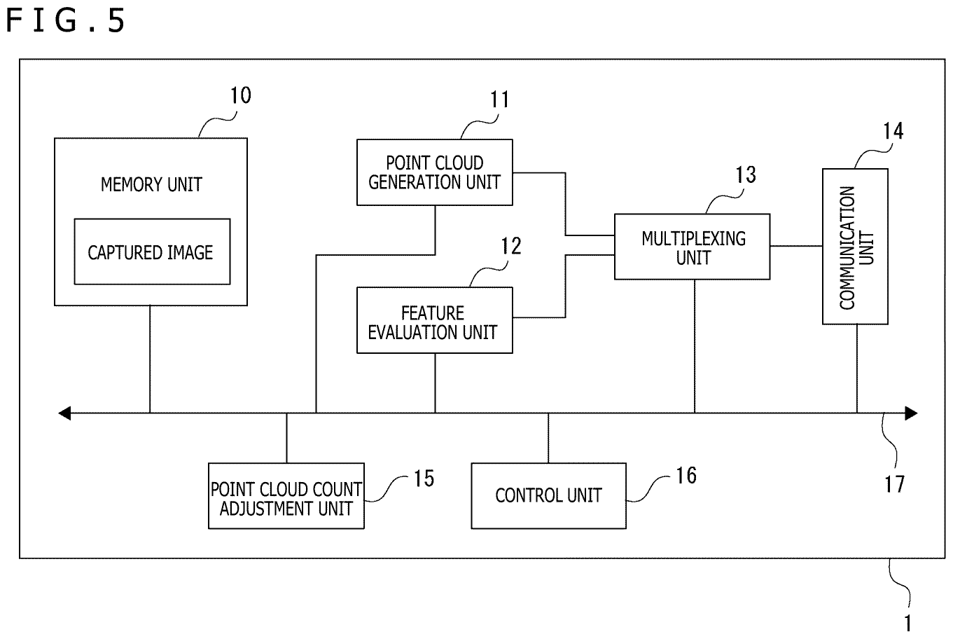

FIG. 5 is a block diagram illustrating an internal configuration example of the information processing apparatus 1.

As illustrated in FIG. 5, the information processing apparatus 1 includes a memory unit 10, a point cloud generation unit 11, a feature evaluation unit 12, a multiplexing unit 13, a communication unit 14, a point cloud count adjustment unit 15, and a control unit 16. These units are capable of mutual data communication via a bus 17.

The memory unit 10 includes a non-volatile memory, such as an HDD (Hard Disk Drive) or an SDD (Solid State Drive), for example, and is used to store various types of data that are handled by the information processing apparatus 1.

In this example, the memory unit 10 stores captured images obtained by the imaging apparatus 3 imaging the target area At. Specifically, the memory unit 10 stores multiple captured images obtained by the imaging apparatus 3 mounted on the moving body M imaging sections different from each other within the target area At.

In this example, the captured images obtained by the imaging apparatus 3 are stored in the memory unit 10 via the communication unit 14. For example, it is conceivable that, after the imaging of the entire target area At by the imaging apparatus 3 is completed, all the captured images are transferred from the imaging apparatus 3 to the information processing apparatus 1 to be stored in the memory unit 10. Alternatively, it is also conceivable that, while the imaging apparatus 3 is imaging the target area At, the captured images are sequentially transferred to the information processing apparatus 1 and the captured images sequentially transferred in such a manner are stored in the memory unit 10.

The point cloud generation unit 11 generates point cloud data indicating the three-dimensional structure of the target area At, on the basis of sensing data regarding the target area At. Specifically, the point cloud generation unit 11 of this example generates point cloud data indicating the three-dimensional structure of the target area At, on the basis of multiple captured images stored in the memory unit 10, which are captured images taken with the moving body M being moved over the target area At.

In this example, the point cloud generation unit 11 generates point cloud data by SfM (Structure from Motion). As is well known, SfM is a technology for determining, from multiple captured images taken while the viewpoint of a camera is being changed, the three-dimensional structure of a target and the camera positions. In SfM, point cloud data indicating the three-dimensional structure of a target is generated on the basis of the result of detection of corresponding points (identical feature points) from multiple captured images taken while the viewpoint of a camera is being changed.

The point cloud data here is generated for each recognized point (the above-mentioned corresponding points) as information in which the coordinate information (X-coordinate, Y-coordinate, and Z-coordinate) in a three-dimensional space is associated with the luminance values of R, G, and B.

The feature evaluation unit 12 evaluates the features of subjects at multiple locations within the target area At on the basis of the result of analysis of captured images in which the target area At is captured. Specifically, the feature evaluation unit 12 in this example performs image recognition processing as semantic segmentation by using an artificial intelligence model trained with machine learning (for example, an artificial intelligence model using CNN (Convolutional Neural Network) or the like) on multiple captured images stored in the memory unit 10, and calculates the degree of being an unnecessary object for point clouds on the basis of this image recognition result. Specifically, the degree of being an unnecessary object is calculated such that the values of the degree of being an unnecessary object of point clouds belonging to a segment in which an object of a specific class is recognized are larger than those of the degree of being an unnecessary object of point clouds belonging to a segment in which an object of a non-specific class is recognized.

In this example, the classes of objects to be recognized in semantic segmentation include the class of unnecessary objects such as construction equipment and buildings, for example. The degree of being an unnecessary object here is calculated such that the degree of being an unnecessary object of point clouds belonging to a segment in which an object of such an unnecessary object class is recognized is larger than the degree of being an unnecessary object of point clouds belonging to a segment in which an object of a non-unnecessary object class is recognized.

Further, in this example, the degree of being an unnecessary object is calculated as a value weighted according to the likelihood of image recognition (evaluation index of recognition certainty) in image recognition processing using the artificial intelligence model.

A specific example is given. For example, for point clouds belonging to a segment in which an object of the unnecessary object class is recognized, as the basic degree of being an unnecessary object, for example, “1.0” is set. Then, this basic degree of being an unnecessary object is multiplied by a coefficient according to the likelihood of image recognition for the segment to calculate the degree of being an unnecessary object of the segment. For example, when the likelihood is “0.8,” a degree of being an unnecessary object of “0.8” is calculated for a basic degree of being an unnecessary object of “1.0.”

Note that, for the degree of being an unnecessary object of point clouds belonging to a segment in which an object of the non-unnecessary object class is recognized, it is conceivable to uniformly set the value to “0,” for example. Alternatively, as in the case of unnecessary objects, it is also conceivable to set a value other than 0 (however, a value smaller than the basic degree of being an unnecessary object of unnecessary objects) as the basic degree of being an unnecessary object, and to calculate, as the degree of being an unnecessary object, a value by weighting the basic degree of being an unnecessary object according to the likelihood of image recognition.

It is noted for confirmation that, in SfM, for multiple captured images with different imaging viewpoints, corresponding points are detected and points in a three-dimensional space are recognized on the basis of the positional relations of the corresponding points in each captured image. It is therefore understood which pixels in the captured images correspond to which points in the point cloud data. Thus, when image recognition processing is performed on captured images, it is understood that the image region in which an object of the target class is recognized corresponds to which point clouds in the point cloud data.

Here, the degree of being an unnecessary object calculated by the feature evaluation unit 12 is an example of evaluation information obtained through evaluation of the features of subjects.

The multiplexing unit 13 receives, as inputs, point cloud data obtained by the point cloud generation unit 11 and the degree of being an unnecessary object (evaluation information regarding the features of subjects) obtained by the feature evaluation unit 12 and obtains multiplexed data by superimposing the degree of being an unnecessary object as metadata on the point cloud data.

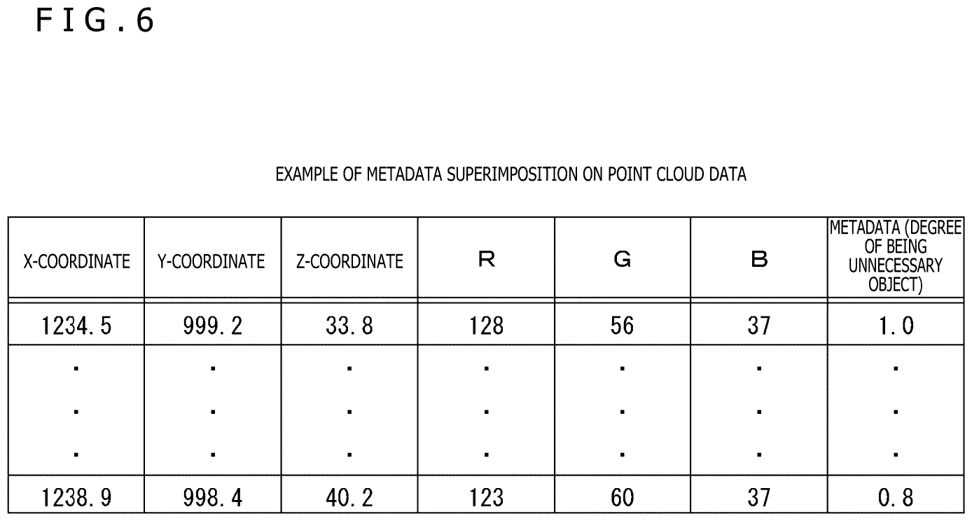

FIG. 6 is a diagram illustrating a structure example of multiplexed data generated by the multiplexing unit 13.

As illustrated in FIG. 6, the multiplexed data is data in which data regarding each point in point cloud data (data in which the information regarding the X-coordinate, the Y-coordinate, and the Z-coordinate is associated with the luminance values of R, G, and B) is associated with the corresponding metadata, that is, the degree of being an unnecessary object in this example.

In FIG. 5, the communication unit 14 comprehensively represents a communication device configured to perform wired/wireless communication with various types of equipment and communication processing via transmission paths such as the Internet. The information processing apparatus 1 is capable of data communication with the imaging apparatus 3 and the user terminal 2 via this communication unit 14.

The point cloud count adjustment unit 15 performs point cloud count adjustment processing for point cloud data generated by the point cloud generation unit 11, on the basis of evaluation information regarding the features of subjects (in this example, the degree of being an unnecessary object) obtained by the feature evaluation unit 12. Specifically, the point cloud count adjustment unit 15 performs point cloud count adjustment processing on the basis of evaluation information regarding the features of subjects obtained by the feature evaluation unit 12 and feature indication information indicated by the control unit 16. The feature indication information here means information for indicating the features of point clouds to be extracted. In this example, the threshold described above, that is, the threshold for the degree of being an unnecessary object, corresponds to the feature indication information.

As is described later, in this example, in response to a threshold confirmation operation at the user terminal 2, the confirmed threshold is transmitted to the information processing apparatus 1 (control unit 16). The point cloud count adjustment unit 15 of this example performs point cloud count adjustment processing for point cloud data on the basis of the threshold transmitted from the user terminal 2 in such a manner and the degree of being an unnecessary object of each point obtained by the feature evaluation unit 12.

The control unit 16 includes a microcomputer including, for example, a CPU, a ROM, a RAM, and the like. The CPU executes processing according to programs stored in the ROM or programs loaded into the RAM, for example, to perform overall control of the information processing apparatus 1.

Specifically, the control unit 16 performs such control as processing execution instructions, for example, for the point cloud data generation processing by the point cloud generation unit 11, the feature evaluation processing by the feature evaluation unit 12, the multiplexed data generation processing by the multiplexing unit 13, and the point cloud count adjustment processing by the point cloud count adjustment unit 15.

Further, the control unit 16 performs data communication with the imaging apparatus 3 and the user terminal 2 (a CPU 21 described later) via the communication unit 14.

In particular, the control unit 16 performs the processing of transmitting (outputting) multiplexed data generated by the multiplexing unit 13 to the user terminal 2 via the communication unit 14, in response to transmission requests from the user terminal 2 side.

With this, the user terminal 2 side can perform display control of point cloud data based on user operations completely within the apparatus itself by using the metadata (in this example, the degree of being an unnecessary object) received together with the point cloud data.

Further, the control unit 16 performs the processing of storing, in the memory unit 10, point cloud data generated by the point cloud generation unit 11 and evaluation information regarding the features of subjects calculated by the feature evaluation unit 12 (in this example, the degree of being an unnecessary object of each point in the point cloud data).

In this example, the point cloud count adjustment unit 15 performs point cloud count adjustment processing by using the point cloud data and evaluation information regarding the features of the subjects stored in the memory unit 10 in such a manner.

### (1-4. User Terminal)

Subsequently, the user terminal 2 is described.

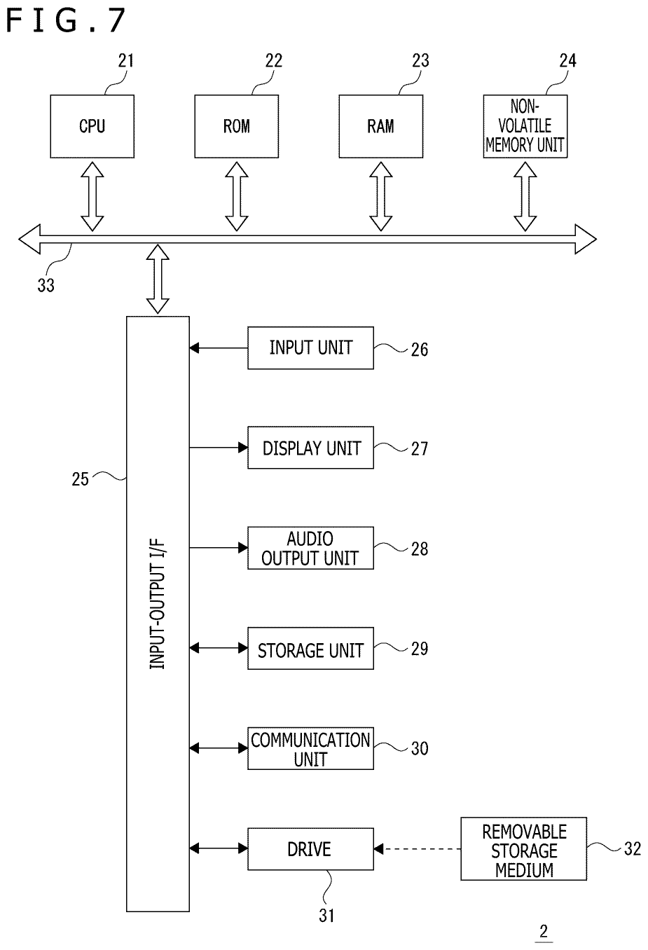

FIG. 7 is a block diagram illustrating an internal configuration example of the user terminal 2.

As illustrated in FIG. 7, the user terminal 2 includes the CPU 21. The CPU 21 functions as an arithmetic processing unit configured to perform various types of processing described so far as the processing of the user terminal 2. The CPU 21 executes the various types of processing according to programs stored in a ROM 22 or a non-volatile memory unit 24, such as an EEP-ROM (Electrically Erasable Programmable Read-Only Memory), for example, or programs loaded into a RAM 23 from a storage unit 29. Further, the RAM 23 also stores as needed, for example, the data necessary for the CPU 21 to execute the various types of processing.

The CPU 21, the ROM 22, the RAM 23, and the non-volatile memory unit 24 are connected to each other via a bus 33. Further, an input-output interface (I/F) 25 is also connected to this bus 33.

An input unit 26 including an operating element or an operating device is connected to the input-output interface 25. For example, as the input unit 26, various types of operating elements and operating devices, such as a keyboard, a mouse, a key, a dial, a touch panel, a touchpad, or a remote controller, is assumed.

User operations are detected by the input unit 26, and signals corresponding to the input operations are interpreted by the CPU 21.

Further, a display unit 27 including an LCD (Liquid Crystal Display) or an organic EL (Electro-Luminescence) panel and an audio output unit 28 including a speaker or the like are connected to the input-output interface 25 integrally or separately.

The display unit 27 is used for displaying various types of information and includes, for example, a display device provided on the housing of the computer apparatus, a separate display device connected to the computer apparatus, or the like.

The display unit 27 displays images for various types of image processing, video of processing targets, and the like on a display screen on the basis of instructions from the CPU 21. Further, the display unit 27 displays various operation menus, icons, messages, and the like, that is, performs display as a GUI (Graphical User Interface), on the basis of instructions from the CPU 21.

The storage unit 29 including an HDD (Hard Disk Drive), a solid-state memory, or the like and a communication unit 30 including a modem or the like are connected to the input-output interface 25 in some cases.

The communication unit 30 performs communication processing via transmission paths such as the Internet and communication with various types of equipment by using wired/wireless communication, bus communication, or the like.

Further, a drive 31 is connected to the input-output interface 25 as needed, and a removable storage medium 32, such as a magnetic disk, an optical disc, a magneto-optical disk, or a semiconductor memory, is appropriately mounted on the drive 31.

The drive 31 can read data files such as programs that are used for each processing process from the removable storage medium 32. The read data files are stored in the storage unit 29, or the images and audio included in the data files are output to the display unit 27 or the audio output unit 28. Further, the computer programs or the like read from the removable storage medium 32 are installed in the storage unit 29 as needed.

In the computer apparatus having the hardware configuration as described above, software (program) for the processing of the present embodiment, for example, can be installed via network communication performed by the communication unit 30 or via the removable storage medium 32. Alternatively, the software may be stored in the ROM 22, the storage unit 29, or the like in advance.

The CPU 21 performs processing operations on the basis of various programs to cause the information processing and communication processing necessary for the above-described user terminal 2 to be executed.

### (1-5. Processing on User Terminal Side)

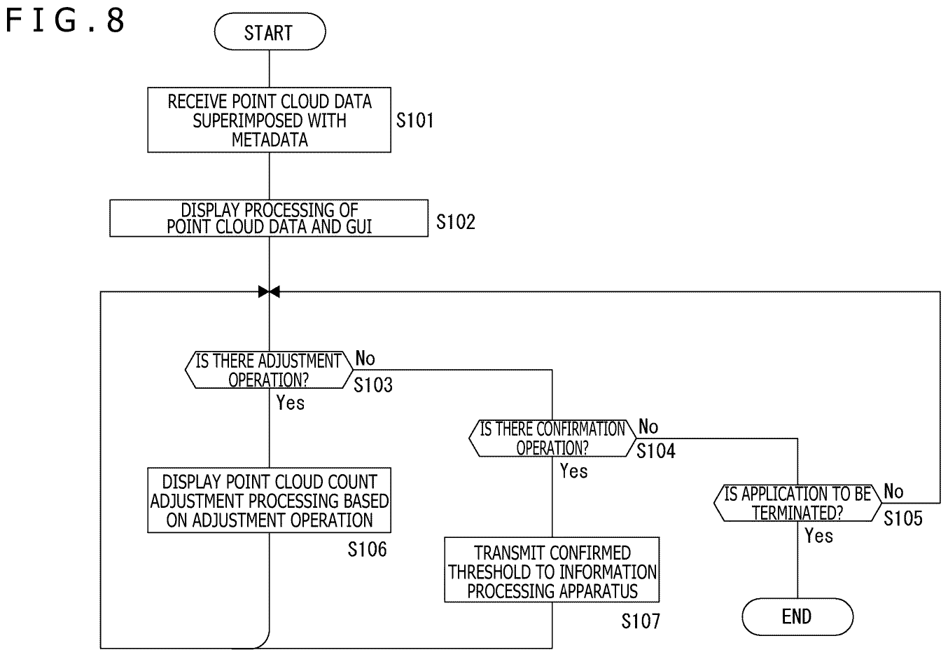

FIG. 8 is a flowchart illustrating processing as the embodiment which is executed by the user terminal 2. The processing illustrated in FIG. 8 is executed by the CPU 21 in the user terminal 2 on the basis of a program stored in a predetermined storage apparatus such as the storage unit 29, for example.

The processing illustrated in FIG. 8 is assumed to be executed by the CPU 21 on the basis of an application (application program) for point cloud count adjustment operation installed in the user terminal 2 in advance. In this example, this application is used by being installed in the storage unit 29 or the like from the information processing apparatus 1 via the communication unit 30.

First, in Step S101, the CPU 21 performs the processing of receiving point cloud data superimposed with metadata. That is, the CPU 21 makes a transmission request to the information processing apparatus 1 (control unit 16) and receives multiplexed data transmitted from the information processing apparatus 1 side in response to the transmission request.

In Step S102 following Step S101, the CPU 21 performs display processing of the point cloud data and a GUI. That is, the CPU 21 performs the processing of displaying, as the point cloud adjustment screen Ga described above, the point cloud adjustment screen Ga including a display image of the point cloud data included in the multiplexed data received in Step S101 and a GUI as the adjustment operator Oa, on the display unit 27.

Note that, as the processing in Step S102, it is also possible to employ a method in which the GUI as the adjustment operator Oa is displayed first on the display unit 27 and, in response to the completion of drawing of the point cloud data received in Step S101, the point cloud data is displayed.

In response to the execution of the display processing in Step S102, the CPU 21 waits for any of an adjustment operation, a confirmation operation, or application termination through the processing in Step S103, Step S104, and Step S105.

Specifically, in Step S103, the CPU 21 determines whether an adjustment operation, that is, a threshold adjustment operation by the user with use of the adjustment operator Oa, has been performed or not. When there is no adjustment operation, the CPU 21 proceeds to Step S104 to determine whether a confirmation operation, that is, a predetermined operation of confirming a threshold, has been performed or not. When there is no confirmation operation, the CPU 21 determines in Step S105 whether the application is to be terminated or not, that is, a predetermined operation of giving an instruction to terminate the application for point count adjustment, has been performed or not. When determining in Step S105 that the application is not to be terminated, the CPU 21 returns to Step S103.

In a case where there is an adjustment operation in Step S103, the CPU 21 proceeds to Step S106 to perform display point cloud count adjustment processing according to the adjustment operation. That is, the CPU 21 performs the processing of adjusting the number of point clouds displayed on the point cloud adjustment screen Ga, by using, as a reference, a threshold specified by the adjustment operation. Specifically, the CPU 21 compares the degree of being an unnecessary object superimposed as metadata with the threshold for each point in the point cloud data, and performs control to display only points with the degree of being an unnecessary object equal to or smaller than the threshold on the point cloud adjustment screen Ga.

In response to the execution of the processing in Step S106, the CPU 21 returns to Step S103. With this, in a case where there is another adjustment operation, the count adjustment processing in Step S106 is executed again. That is, each time the user moves the adjustment operator Oa, the number of point clouds displayed on the point cloud adjustment screen Ga is adjusted.

In a case where there is a confirmation operation in Step S104, the CPU 21 proceeds to Step S107 to perform the processing of transmitting the confirmed threshold to the information processing apparatus 1, and returns to Step S103.

Further, in a case where the CPU 21 determines in Step S105 that the application is to be terminated, the CPU 21 ends the series of processing processes illustrated in FIG. 8.

Here, as described above, the user terminal 2 outputs the threshold confirmed by the processing in Step S107 to the information processing apparatus 1, and in the information processing apparatus 1, on the basis of the threshold output from the user terminal 2 in such a manner, the point cloud count adjustment unit 15 performs point cloud count adjustment processing. This point cloud count adjustment processing is performed as a kind of final count adjustment processing for storing, in the information processing apparatus 1, point cloud data with the number of point clouds confirmed by user operations.

In the information processing apparatus 1, the point cloud data with the number of point clouds adjusted in such final count adjustment processing is stored in a predetermined storage apparatus such as the memory unit 10, for example, under the control of the control unit 16. The user can use the user terminal 2 to cause the point cloud data stored in the information processing apparatus 1 in such a manner to be transmitted to the user terminal 2 and displayed on the display unit 27 for viewing.

At this time, the user terminal 2 outputs, on the assumption that the point cloud data with the confirmed number of point clouds is stored on the information processing apparatus 1 side as described above, not the point cloud data with the confirmed number of point clouds but the confirmed threshold (feature indication information) to the information processing apparatus 1 side.

With this, it is possible to reduce the amount of transmission data when point cloud data with the confirmed number of point clouds is stored in the information processing apparatus 1.

### (1-6. Another Example Related to Feature Evaluation)

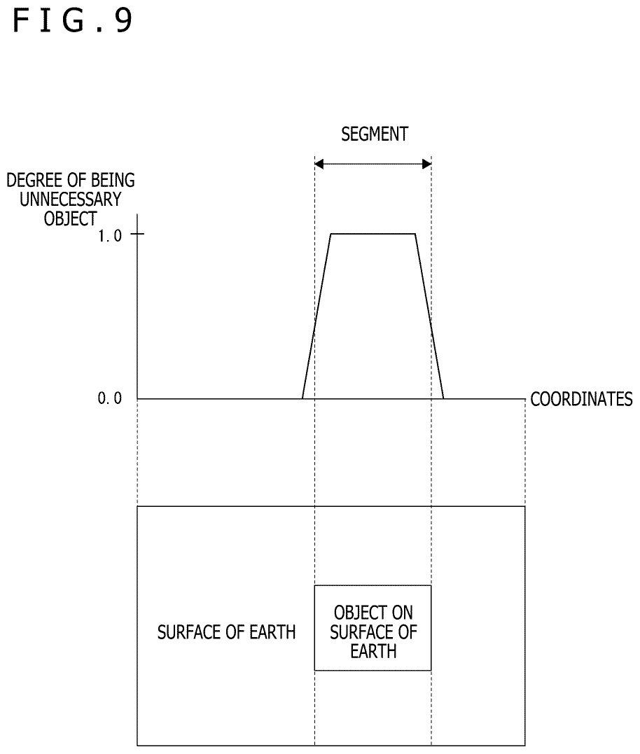

Here, in the example given above, as the degree of being an unnecessary object, the same value is assigned within the segment. However, as exemplified in FIG. 9, for example, the degree of being an unnecessary object can also be calculated such that the value at the edge portion of a segment is smaller than the value at the inner portion of the edge portion.

Specifically, in the example of FIG. 9, it is illustrated that the degree of being an unnecessary object of a point cloud belonging to the edge portion of a segment in which an unnecessary object (an object of a specific class) is recognized is set such that a point located more externally has a smaller degree of being an unnecessary object.

With this, regarding a segment of a class estimated to be an unnecessary object, it is possible to adjust the size of the contour of the range to be removed, through threshold adjustment by the adjustment operator Oa.

Thus, it is possible to achieve an excellent user interface that can appropriately adjust the size of the range to be removed as an unnecessary object, through threshold adjustment.

Here, the slope of the degree of being an unnecessary object at the edge portion of a segment in which an unnecessary object is recognized can also be extended, in a case where a region recognized as a non-unnecessary object is adjacent to the segment, to the edge portion of the region of the non-unnecessary object. In the example illustrated in FIG. 9, the slope of the degree of being an unnecessary object at the edge portion of a segment in which an unnecessary object (in FIG. 9, an object on the surface of the earth) is recognized is extended to the edge portion of the region of a non-unnecessary object (in FIG. 9, the surface of the earth) adjacent to this segment of the unnecessary object.

The slope of the degree of being an unnecessary object is extended to the edge portion of the region of a non-unnecessary object in such a manner, thereby making it possible to make the change width in the number of point clouds with respect to changes in a threshold gentle, even for a region recognized as a non-unnecessary object.

Further, in the description so far, the degree of being an unnecessary object has been exemplified as an example of evaluation information (feature evaluation information) obtained through evaluation of the features of subjects at multiple locations within the target area At. However, the feature evaluation information can also be information regarding the classes of objects recognized in image recognition processing as semantic segmentation, for example. In this case, the information processing apparatus 1 (control unit 16) performs the processing of superimposing, as metadata, information indicating the classes of objects recognized in image recognition processing of the feature evaluation unit 12 on point cloud data and outputting the resultant to the user terminal 2.

The user terminal 2 in this case performs, as display point cloud count adjustment processing, not adjustment based on a threshold specified by operations but adjustment based on information regarding an unnecessary object class specified by operations.

Specifically, the user terminal 2 performs the processing of removing point clouds belonging to a segment in which an object of a specified unnecessary object class is recognized. Note that the information specifying an unnecessary object class here corresponds to an example of “feature indication information” in the present technology.

Note that, in the above, it has been assumed that the user is allowed to specify the unnecessary object class, but in a case where it is possible to recognize objects of the non-unnecessary object class in image recognition processing, it is also possible to allow the user to specify the non-unnecessary object class. In this case, the user terminal 2 performs, as display point cloud count adjustment processing, the processing of removing point clouds other than point clouds belonging to a segment in which an object of a specified class is recognized.

### (1-7. Another Example Related to Metadata Superimposition)

In the example given above, the metadata is superimposed for each point of the point cloud data, but it is not essential to superimpose metadata for each point.

For example, regarding point clouds with the same feature evaluation information, it is conceivable to superimpose the feature evaluation information for some points and not superimpose the feature evaluation information for the remaining points.

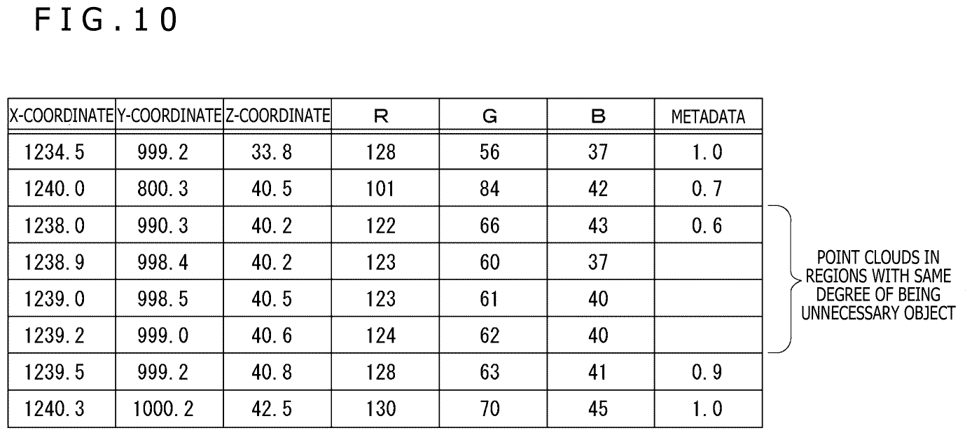

FIG. 10 illustrates an example of metadata superimposition in a case where the feature evaluation information is the degree of being an unnecessary object.

As illustrated in FIG. 10, regarding point clouds in regions with the same degree of being an unnecessary object, the degree of being an unnecessary object is superimposed for some points, specifically, a single point belonging to one of the regions in the example illustrated in FIG. 10, and the degree of being an unnecessary object is not superimposed for the remaining points. It is noted for confirmation that this processing is performed by the multiplexing unit 13.

The metadata superimposition method as described above is employed to make it possible to reduce the data amount of data to be transmitted to the user terminal 2.

Note that the metadata superimposition method as described with FIG. 10 is suitably applicable not only to a case where the feature evaluation information is the degree of being an unnecessary object but also to a case where the feature evaluation information is information regarding the classes of objects recognized by an image processing apparatus, as described above as the other example.

### 2. Second Embodiment

Subsequently, a second embodiment is described. The second embodiment calculates vegetation evaluation values based on wavelength analysis images obtained by a multispectral camera (also called a “multispectrum camera”), as evaluation information regarding the features of subjects.

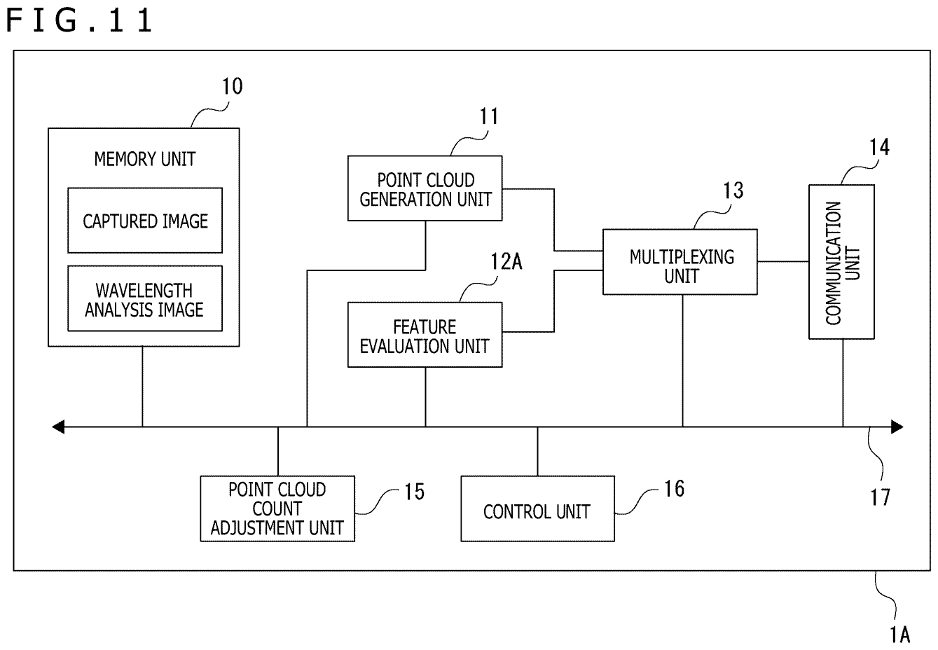

FIG. 11 is a block diagram illustrating an internal configuration example of an information processing apparatus 1A as the second embodiment.

Note that, in the following description, portions similar to the portions already described are denoted by the same reference signs and the description thereof is omitted.

Although not illustrated, an information processing system in the second embodiment includes the moving body M, the imaging apparatus 3, and the user terminal 2 together with the information processing apparatus 1A. Further, in the second embodiment, a multispectral camera is mounted on the moving body M together with the imaging apparatus 3.

Moreover, in the second embodiment, it is assumed that the target area At is not a construction site but an area in which plants are cultivated, such as a field, for example.

Here, the multispectral camera means a camera configured to obtain multiple narrowband images, specifically, narrowband images of at least four or more wavelength bands, as captured images. As is well known, multiple narrowband images obtained by a multispectral camera indicate the amount of received light for each wavelength band regarding incident light from the same subject. Hence, the multiple narrowband images obtained by the multispectral camera can be rephrased as wavelength analysis images obtained through analysis of how much light of each wavelength band is included in the incident light from the subject.

In the information processing system of the second embodiment, while the moving body M having mounted thereon the imaging apparatus 3 and the multispectral camera are being moved over the target area At, the imaging apparatus 3 and the multispectral camera are caused to execute imaging for each section of the target area At. That is, as captured images obtained by the imaging apparatus 3 and as wavelength analysis images obtained by the multispectral camera, multiple images in which different sections within the target area At are captured are obtained.

In FIG. 11, the information processing apparatus 1A is different from the information processing apparatus 1 in that a feature evaluation unit 12A is provided instead of the feature evaluation unit 12. Further, in this case, the memory unit 10 stores wavelength analysis images obtained by the multispectral camera in addition to captured images obtained by the imaging apparatus 3. These captured images and wavelength analysis images are multiple captured images and wavelength analysis images that capture different sections within the target area At and that are obtained by executing the imaging operations of the imaging apparatus 3 and the multispectral camera while moving the moving body M, as described above.

Also in this case, the point cloud generation unit 11 generates point cloud data indicating the three-dimensional structure of the target area At by SfM, for example, on the basis of multiple captured images stored in the memory unit 10.

The feature evaluation unit 12A calculates evaluation values related to vegetation (vegetation evaluation values) for each point in point cloud data on the basis of multiple wavelength analysis images stored in the memory unit 10. Specifically, in this example, as the vegetation evaluation value, NDVI (Normalized Difference Vegetation Index) is calculated.

The NDVI can be calculated on the basis of a narrowband image (R image) having a wavelength of 660 nm as its center wavelength and a narrowband image (NIR image) having a wavelength of 800 nm as its center wavelength. Specifically, the NDVI is calculated by the following, for example:

$$NDVI = ( 1 - ( R / NIR ) ) / ( 1 + ( R / NIR ) )$$

Such NDVI has a feature of indicating a large value in a case where the vegetation is dense.

The multiplexing unit 13 in this case receives, as inputs, point cloud data generated by the point cloud generation unit 11 and NDVI generated by the feature evaluation unit 12A and generates multiplexed data by superimposing the NDVI as metadata on the point cloud data.

Then, the control unit 16 in this case performs the processing of outputting multiplexed data generated by the multiplexing unit 13 as described above to the user terminal 2 via the communication unit 14, in response to transmission requests from the user terminal 2.

In this case, as an application for point cloud count adjustment operation in the user terminal 2, there is used an application that receives the operation of specifying a threshold for NDVI and performs display point cloud count adjustment processing on the basis of the specified threshold and NDVI included in multiplexed data received from the information processing apparatus 1A. Specifically, it is conceivable that the point cloud count adjustment processing in this case is performed as the processing of extracting point clouds with NDVI equal to or greater than the threshold.

With this, regarding the target area At such as a field, it is possible to extract only point cloud data regarding regions with dense vegetation (that is, regions in which the possibility of plant existence is high), and to use the point cloud data obtained after the extraction, as data indicating regions for application of water, fertilizer, pesticide, or the like by spraying.

Note that, also in the second embodiment, in a case where there is a threshold confirmation operation, the user terminal 2 (CPU 21) performs the processing of outputting the confirmed threshold to the information processing apparatus 1A.

In the information processing apparatus 1A, in a case where the control unit 16 receives the confirmed threshold from the user terminal 2, the control unit 16 causes the point cloud count adjustment unit 15 to execute point cloud count adjustment processing based on the confirmed threshold for point cloud data generated by the point cloud generation unit 11 (for example, the processing of extracting point clouds with NDVI equal to or greater than the threshold). Then, the control unit 16 performs the processing of storing, in a predetermined storage apparatus such as the memory unit 10, the point cloud data subjected to the adjustment processing by the point cloud count adjustment unit 15.

Note that, also in the second embodiment, the metadata superimposition method for reducing the amount of data as described with FIG. 10 referred to above can be employed. Specifically, regarding points with the same vegetation evaluation value, the vegetation evaluation value is superimposed only for some points, and the vegetation evaluation value is not superimposed for the remaining points.

### 3. Modified Example

The first and second embodiments according to the present technology have been described above, but the present technology is not limited to the specific examples described above and can employ various configurations as modified examples.

For example, in the example given above, the apparatus configured to perform (final) point cloud count adjustment processing on the basis of a confirmed threshold and store the point cloud data obtained after the point cloud count adjustment processing (hereinafter referred to as a “point cloud data storage apparatus”) is assumed to be the information processing apparatus 1 (or 1A) configured to generate point cloud data. However, the point cloud data storage apparatus can also be an apparatus different from an apparatus configured to generate point cloud data and an apparatus configured to perform display control of point cloud data, such as the user terminal 2.

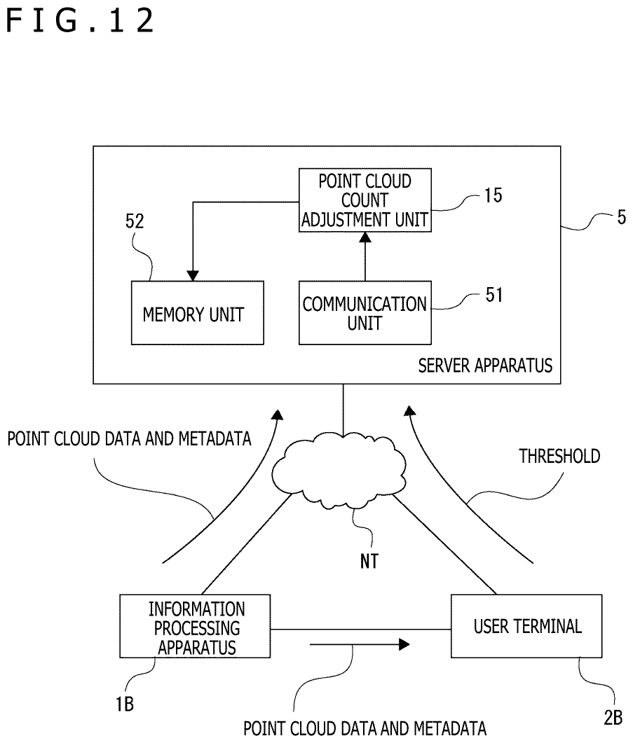

FIG. 12 is a diagram illustrating a configuration example of an information processing system as a modified example in which a point cloud data storage apparatus is an apparatus different from an apparatus configured to generate point cloud data and an apparatus configured to perform display control of point cloud data as described above.

The information processing system as the modified example includes an information processing apparatus 1B, a user terminal 2B, and a server apparatus 5. In this case, the server apparatus 5 corresponds to the point cloud data storage apparatus.

In the information processing system as the modified example, the information processing apparatus 1B, the user terminal 2B, and the server apparatus 5 are capable of data communication via a predetermined network NT, such as the Internet or a LAN (Local Area Network), for example.

As illustrated in FIG. 12, the server apparatus 5 includes a communication unit 51 and a memory unit 52, as well as the point cloud count adjustment unit 15. The communication unit 51 is provided to perform data communication with the information processing apparatus 1B and the user terminal 2B via the network NT.

The memory unit 52 is used as a storage memory for point cloud data obtained after adjustment.

The information processing apparatus 1 is different from the information processing apparatus 1A in that the point cloud count adjustment unit 15 is omitted. Further, in the information processing apparatus 1B, the control unit 16 performs the processing of outputting multiplexed data including point cloud data and metadata to the user terminal 2B as well as to the server apparatus 5.

The user terminal 2B receives a threshold specification operation and performs, on the basis of the specified threshold and evaluation information as metadata (for example, the degree of being an unnecessary object or vegetation evaluation values), display point cloud count adjustment processing, as with the case of the user terminal 2. However, the user terminal 2B outputs, in response to a threshold confirmation operation, the confirmed threshold to the server apparatus 5.

In the server apparatus 5, the point cloud count adjustment unit 15 performs, on the basis of point cloud data and metadata output from the information processing apparatus 1B and a threshold output from the user terminal 2B as described above, point count adjustment processing for the point cloud data. Then, in the server apparatus 5, the point cloud data subjected to the point cloud count adjustment processing by the point cloud count adjustment unit 15 in such a manner is stored in the memory unit 52.

As described above, in the information processing system as the modified example, the information processing apparatus 1B performs the processing of outputting point cloud data superimposed with metadata to the server apparatus 5, that is, a separate external apparatus, which is an external apparatus different from the user terminal 2B and performs point cloud data count adjustment processing on the basis of a threshold (feature indication information).

With this, in the server apparatus 5 as a separate external apparatus, a threshold (feature indication information) confirmed by user operations is received from the user terminal 2B configured to perform display control of point cloud data, thereby making it possible to perform final count adjustment processing for point cloud data.

Note that, in the information processing system as the modified example described above, it is also conceivable that an application for performing display point cloud count adjustment processing is stored in the server apparatus 5 and the user terminal 2B downloads and uses the application from the server apparatus 5.

Here, in the example described so far, the point cloud data is generated by SfM on the basis of captured images of the target area At, but the point cloud data can also be generated by, for example, SLAM (Simultaneous Localization And Mapping) technology on the basis of captured images of the target area At.

Alternatively, the point cloud data can also be generated on the basis of data obtained by sensing the target area At by a depth sensor such as a LiDAR (Light Detection And Ranging) sensor or a ToF (Time Of Flight) sensor. That is, it is not essential to use captured images for point cloud data generation, and it is sufficient if the point cloud data is generated on the basis of sensing data regarding the target area At.

### 4. Summary of Embodiments

As described above, an information processing apparatus (information processing apparatus 1, 1A, or 1B) as the embodiment includes a point cloud generation unit (point cloud generation unit 11) configured to generate point cloud data indicating a three-dimensional structure of a target area, on the basis of sensing data regarding the target area, a feature evaluation unit (feature evaluation unit 12 or 12A) configured to evaluate a feature of a subject within the target area on the basis of a result of analysis of a captured image in which the target area is captured, an associating unit (multiplexing unit 13) configured to associate evaluation information regarding the feature with the point cloud data, and an output processing unit (control unit 16) configured to perform processing of outputting the point cloud data and the evaluation information associated with the point cloud data to an external apparatus.

With the above-mentioned configuration, in a case where the external apparatus is an apparatus configured to perform display control of point cloud data based on user operations, the external apparatus can perform display control of point cloud data based on user operations completely within the apparatus itself by using the feature evaluation information received together with the point cloud data.

Thus, it is possible to improve, in a case where an external apparatus different from an apparatus configured to generate point cloud data performs display control of point cloud data based on user operations, the response speed at which display of point cloud data based on an operation performed by a user is performed after the user operation.

Further, in the information processing apparatus as the embodiment, the output processing unit performs the processing of outputting the point cloud data and the evaluation information to the external apparatus (user terminal 2 or 2B) which is an apparatus configured to perform display control of the point cloud data on the basis of the evaluation information regarding the feature and a user operation related to the evaluation information regarding the feature.

With this, the external apparatus configured to perform display control of point cloud data on the basis of user operations related to feature evaluation information can perform display control of point cloud data based on user operations completely within the apparatus itself by using the evaluation information received together with the point cloud data.

Thus, it is possible to improve the response speed at which display of point cloud data based on an operation performed by the user is performed after the user operation.

Moreover, in the information processing apparatus as the embodiment, the feature evaluation unit generates a feature evaluation value by quantifying the feature of the subject, and the associating unit associates the feature evaluation value as the evaluation information with the point cloud data.

With this, it is possible to achieve a system capable of performing point cloud count adjustment through the operation of specifying a threshold for feature evaluation values.

In addition, in the information processing apparatus (information processing apparatus 1) as the embodiment, the feature evaluation unit calculates a degree of being an unnecessary object as the feature evaluation value.

The degree of being an unnecessary object here means an evaluation value indicating the likelihood of being an unnecessary object, which is an object other than the surface of the earth.

Thus, with the above-mentioned configuration, it is possible to achieve a system capable of adjusting the point cloud range of an unnecessary object through the operation of specifying a threshold for the degree of being an unnecessary object.

Further, in the information processing apparatus as the embodiment, the feature evaluation unit performs image recognition processing as semantic segmentation on the captured image, and calculates the degree of being an unnecessary object such that a value of the degree of being an unnecessary object of a point cloud belonging to a segment in which an object of a specific class is recognized is larger than a value of the degree of being an unnecessary object of a point cloud belonging to a segment in which an object of a non-specific class is recognized (see FIG. 9).

With this, the values of the degree of being an unnecessary object of point clouds belonging to a segment of a class corresponding to unnecessary objects such as construction equipment and buildings, for example, are calculated to be larger than those of the degree of being an unnecessary object of point clouds belonging to a segment of a class not corresponding to unnecessary objects.

Thus, it is possible to appropriately calculate the degree of being an unnecessary object.

Moreover, in the information processing apparatus as the embodiment, the feature evaluation unit weights the degree of being an unnecessary object according to a likelihood of image recognition in the image recognition processing.

With this, it is possible to achieve a system capable of appropriately adjusting the point cloud range of an unnecessary object on the basis of the likelihood of image recognition.

In addition, in the information processing apparatus as the embodiment, the feature evaluation unit sets the degree of being an unnecessary object of a point cloud belonging to an edge portion of the segment in which the object of the specific class is recognized, such that a point located more externally has a smaller degree of being an unnecessary object (see FIG. 9).

With this, regarding a segment of a class estimated to be an unnecessary object, it is possible to adjust the size of the contour of a range to be removed, through threshold adjustment.

Thus, it is possible to achieve an excellent user interface that can appropriately adjust the size of a range to be removed as an unnecessary object, through threshold adjustment.

Further, in the information processing apparatus as the embodiment, regarding points with the same evaluation information regarding the feature, the associating unit associates the evaluation information regarding the feature for some points but does not associate the evaluation information regarding the feature for remaining points (see FIG. 10).

With this, it is possible to reduce the data amount of data to be transmitted to the external apparatus.

Moreover, in the information processing apparatus as the embodiment, the feature evaluation unit performs image recognition processing as semantic segmentation on the captured image, and the associating unit associates, as the evaluation information, information indicating a class of an object recognized in the image recognition processing with the point cloud data.

With this, it is possible to achieve a user interface configured to allow the user to specify the classes of objects to be extracted or removed, to thereby perform point cloud count adjustment.

In addition, in the information processing apparatus (information processing apparatus 1A) as the embodiment, the feature evaluation unit (feature evaluation unit 12A) calculates a vegetation evaluation value on the basis of a captured image obtained by a multispectral camera, and the associating unit associates the vegetation evaluation value as the evaluation information with the point cloud data.

With this, it is possible to achieve a user interface capable of adjusting the regions for application of water, fertilizer, or the like by spraying for, for example, fields, through the operation of specifying a threshold for vegetation evaluation values.

### Item 11

Further, in the information processing apparatus (information processing apparatus 1B) as the embodiment, the output processing unit performs the processing of outputting the point cloud data and the evaluation information associated with the point cloud data to a separate external apparatus (server apparatus 5) which is an external apparatus different from the external apparatus (user terminal 2B) and performs point cloud data count adjustment processing on the basis of feature indication information indicating a feature of a point cloud to be extracted (see FIG. 12).

With this, in the separate external apparatus, feature indication information confirmed by user operations is received from the external apparatus configured to perform display control of point cloud data, thereby making it possible to perform final count adjustment processing for point cloud data.

Further, data structure as the embodiment is a data structure of data to be output by an information processing apparatus to an external apparatus. The information processing apparatus includes a point cloud generation unit configured to generate point cloud data indicating a three-dimensional structure of a target area, on the basis of sensing data regarding the target area, a feature evaluation unit configured to evaluate a feature of a subject within the target area on the basis of a result of analysis of a captured image in which the target area is captured, and an associating unit configured to associate evaluation information regarding the feature with the point cloud data. The external apparatus is configured to perform display control of the point cloud data. The data structure includes the point cloud data and the evaluation information associated with the point cloud data. The external apparatus uses the data structure to perform display control of the point cloud data according to a user operation on the basis of the evaluation information received.

With this, the external apparatus configured to perform display control of point cloud data based on user operations can perform display control of point cloud data based on user operations completely within the apparatus itself by using the feature evaluation information received together with the point cloud data.

Thus, it is possible to improve, in a case where an external apparatus different from an apparatus configured to generate point cloud data performs display control of point cloud data based on user operations, the response speed at which display of point cloud data based on an operation performed by the user is performed after the user operation.

Here, as the embodiment, conceivable is a program for causing, for example, a CPU, a DSP (Digital Signal Processor), or the like or a device including them to execute the processing on the user terminal 2 side described with FIG. 8 and the like referred to above.

That is, a program as the embodiment is a program readable by a computer apparatus, for causing the computer apparatus to execute processing of receiving, from an information processing apparatus including a point cloud generation unit configured to generate point cloud data indicating a three-dimensional structure of a target area, on the basis of sensing data regarding the target area, a feature evaluation unit configured to evaluate a feature of a subject within the target area on the basis of a result of analysis of a captured image in which the target area is captured, and an associating unit configured to associate evaluation information regarding the feature with the point cloud data, the point cloud data and the evaluation information associated with the point cloud data, and performing display control of the point cloud data according to a user operation on the basis of the evaluation information.

With such a program, it is possible to achieve the function as the above-described user terminal 2 through software processing performed by the computer apparatus.

The program as described above can be recorded in advance in an HDD as a recording medium built in equipment such as a computer apparatus, a ROM in a microcomputer including a CPU, or the like.

Alternatively, in addition, the program can temporarily or permanently be stored (recorded) in a removable recording medium such as a flexible disk, a CD-ROM (Compact Disc Read Only Memory), an MO (Magneto Optical) disk, a DVD (Digital Versatile Disc), a Blu-ray Disc (registered trademark), a magnetic disk, a semiconductor memory, or a memory card. Such a removable recording medium can be provided as what is generally called package software.

Further, such a program can be installed in a personal computer or the like from a removable recording medium or can also be downloaded from a download site via a network such as a LAN or the Internet.

Further, such a program is suitable for the widespread provision of the user terminal 2 as the embodiment. For example, the program is downloaded to a personal computer, a portable information processing apparatus, a cell phone, a game console, a video device, a PDA (Personal Digital Assistant), or the like to allow the personal computer or the like to function as an apparatus configured to achieve the processing as the user terminal 2 of the present disclosure.

Further, regarding the program as the embodiment, it is also conceivable that the program is a program for causing the computer apparatus to execute processing of selecting some of multiple points included in the point cloud data on the basis of the evaluation information associated with the point cloud data and the user operation.

With this, it is possible to select display point clouds based not only on user operations but also on evaluation information.

Moreover, regarding the program as the embodiment, it is also conceivable that the program is a program for causing the computer apparatus to execute processing of selecting, among the multiple points, a point satisfying a condition related to the evaluation information specified by the user operation.

With this, it is possible to reduce the user's operational burden related to the selection of display point clouds without causing the user to perform cumbersome operations of specifying display point clouds one by one.

In addition, regarding the program as the embodiment, it is conceivable that the evaluation information is a feature evaluation value obtained by quantifying the feature and the condition is a condition determined by a threshold for the feature evaluation value.

With this, it is possible to make the user operation required for the selection of display point clouds the operation of specifying a threshold for feature evaluation values, thereby reducing the user's operational burden related to the selection of display point clouds.

Further, regarding the program as the embodiment, it is also conceivable that the program is a program for causing the computer apparatus to further execute processing of outputting, to an apparatus configured to perform count adjustment of the point cloud data (information processing apparatus 1 or 1A or server apparatus 5), feature indication information which has been confirmed by the user operation and indicates a feature of a point cloud to be extracted.

With this, feature indication information confirmed by user operations is output to the apparatus configured to perform point cloud data count adjustment, such as an apparatus configured to generate point cloud data or a server apparatus, for example.

Thus, in a case where the apparatus configured to store point cloud data with the number of point clouds adjusted on the basis of confirmed feature indication information is assumed to be an external apparatus of an apparatus configured to perform display control of point cloud data, such as an apparatus configured to generate point cloud data or a server apparatus, there is no need to transmit point cloud data with the number of point clouds adjusted on the basis of user operations from the apparatus configured to perform display control of point cloud data to the external apparatus. That is, it is possible to reduce the amount of transmission data when point cloud data with the confirmed number of point clouds is stored in the external apparatus.

Note that the effects described herein are merely examples and are not limitative, and other effects may also be provided.

### 5. Present Technology

The present technology can also be configured as follows.

(1)

An information processing apparatus including:
a point cloud generation unit configured to generate point cloud data indicating a three-dimensional structure of a target area, on the basis of sensing data regarding the target area;
a feature evaluation unit configured to evaluate a feature of a subject within the target area on the basis of a result of analysis of a captured image in which the target area is captured;
an associating unit configured to associate evaluation information regarding the feature with the point cloud data; and
an output processing unit configured to perform processing of outputting the point cloud data and the evaluation information associated with the point cloud data to an external apparatus.
   (2)

The information processing apparatus according to (1) above,
in which the output processing unit performs the processing of outputting the point cloud data and the evaluation information to the external apparatus which is an apparatus configured to perform display control of the point cloud data on the basis of the evaluation information regarding the feature and a user operation related to the evaluation information regarding the feature.
   (3)

The information processing apparatus according to (1) or (2) above,
in which the feature evaluation unit generates a feature evaluation value by quantifying the feature of the subject, and
the associating unit associates the feature evaluation value as the evaluation information with the point cloud data.
   (4)

The information processing apparatus according to (3) above,
in which the feature evaluation unit calculates a degree of being an unnecessary object as the feature evaluation value.
   (5)

The information processing apparatus according to (4) above,
in which the feature evaluation unit performs image recognition processing as semantic segmentation on the captured image, and calculates the degree of being an unnecessary object such that a value of the degree of being an unnecessary object of a point cloud belonging to a segment in which an object of a specific class is recognized is larger than a value of the degree of being an unnecessary object of a point cloud belonging to a segment in which an object of a non-specific class is recognized.
   (6)

The information processing apparatus according to (5) above,
in which the feature evaluation unit weights the degree of being an unnecessary object according to a likelihood of image recognition in the image recognition processing.
   (7)

The information processing apparatus according to (5) or (6) above,
in which the feature evaluation unit sets the degree of being an unnecessary object of a point cloud belonging to an edge portion of the segment in which the object of the specific class is recognized, such that a point located more externally has a smaller degree of being an unnecessary object.
   (8)

The information processing apparatus according to (1) or (2) above,
in which, regarding point clouds with the same evaluation information regarding the feature, the associating unit associates the evaluation information regarding the feature for some points but does not associate the evaluation information regarding the feature for remaining points.
   (9)

The information processing apparatus according to (1), (2), or (8) above,
in which the feature evaluation unit performs image recognition processing as semantic segmentation on the captured image, and
the associating unit associates, as the evaluation information, information indicating a class of an object recognized in the image recognition processing with the point cloud data.
   (10)

The information processing apparatus according to (1), (2), or (8) above,
in which the feature evaluation unit calculates a vegetation evaluation value on the basis of a captured image obtained by a multispectral camera, and
the associating unit associates the vegetation evaluation value as the evaluation information with the point cloud data.
   (11)

The information processing apparatus according to any one of (2) to (10) above,
in which the output processing unit performs the processing of outputting the point cloud data and the evaluation information associated with the point cloud data to a separate external apparatus which is an external apparatus different from the external apparatus and performs point cloud data count adjustment processing on the basis of feature indication information indicating a feature of a point cloud to be extracted.
   (12)

A data structure of data to be output by an information processing apparatus to an external apparatus,
the information processing apparatus including
   a point cloud generation unit configured to generate point cloud data indicating a three-dimensional structure of a target area, on the basis of sensing data regarding the target area,
   a feature evaluation unit configured to evaluate a feature of a subject within the target area on the basis of a result of analysis of a captured image in which the target area is captured, and
   an associating unit configured to associate evaluation information regarding the feature with the point cloud data,
the external apparatus being configured to perform display control of the point cloud data,
the data structure including:
the point cloud data; and
the evaluation information associated with the point cloud data,
in which the external apparatus uses the data structure to perform display control of the point cloud data according to a user operation on the basis of the evaluation information received.
   (13)

A program readable by a computer apparatus, for causing the computer apparatus to execute processing of:
receiving, from an information processing apparatus including a point cloud generation unit configured to generate point cloud data indicating a three-dimensional structure of a target area, on the basis of sensing data regarding the target area, a feature evaluation unit configured to evaluate a feature of a subject within the target area on the basis of a result of analysis of a captured image in which the target area is captured, and an associating unit configured to associate evaluation information regarding the feature with the point cloud data, the point cloud data and the evaluation information associated with the point cloud data; and
performing display control of the point cloud data according to a user operation on the basis of the evaluation information.
   (14)

The program according to (13) above,
in which the computer apparatus is caused to execute processing of selecting some of multiple points included in the point cloud data on the basis of the evaluation information associated with the point cloud data and the user operation.
   (15)

The program according to (14) above,
in which the computer apparatus is caused to execute processing of selecting, among the multiple points, a point satisfying a condition related to the evaluation information specified by the user operation.
   (16)

The program according to (15) above,
in which the evaluation information is a feature evaluation value obtained by quantifying the feature, and
the condition is a condition determined by a threshold for the feature evaluation value.
   (17)

The program according to any one of (13) to (16) above,
in which the computer apparatus is caused to execute processing of outputting, to an apparatus configured to perform count adjustment of the point cloud data, feature indication information which has been confirmed by the user operation and indicates a feature of a point cloud to be extracted.

### REFERENCE SIGNS LIST

1, 1A, 1B: Information processing apparatus
2, 2B: User terminal
3: Imaging apparatus
At: Target area
Oa: Adjustment operator
Ga: Point cloud adjustment screen
10: Memory unit
11: Point cloud generation unit
12, 12A: Feature evaluation unit
13: Multiplexing unit
14: Communication unit
15: Point cloud count adjustment unit
16: Control unit
17: Bus
21: CPU
22: ROM
23: RAM
24: Non-volatile memory unit
25: Input-output interface
26: Input unit
27: Display unit
29: Storage unit
30: Communication unit
5: Server apparatus
51: Communication unit
52: Memory unit
NT: Network

1. An information processing apparatus comprising:
a point cloud generation unit configured to generate point cloud data indicating a three-dimensional structure of a target area, on a basis of sensing data regarding the target area;
a feature evaluation unit configured to evaluate a feature of a subject within the target area on a basis of a result of analysis of a captured image in which the target area is captured;
an associating unit configured to associate evaluation information regarding the feature with the point cloud data; and
an output processing unit configured to perform processing of outputting the point cloud data and the evaluation information associated with the point cloud data to an external apparatus.

2. The information processing apparatus according to claim 1,
wherein the output processing unit performs the processing of outputting the point cloud data and the evaluation information to the external apparatus which is an apparatus configured to perform display control of the point cloud data on a basis of the evaluation information regarding the feature and a user operation related to the evaluation information regarding the feature.

3. The information processing apparatus according to claim 1,
wherein the feature evaluation unit generates a feature evaluation value by quantifying the feature of the subject, and
the associating unit associates the feature evaluation value as the evaluation information with the point cloud data.

4. The information processing apparatus according to claim 3,
wherein the feature evaluation unit calculates a degree of being an unnecessary object as the feature evaluation value.

5. The information processing apparatus according to claim 4,
wherein the feature evaluation unit performs image recognition processing as semantic segmentation on the captured image, and calculates the degree of being an unnecessary object such that a value of the degree of being an unnecessary object of a point cloud belonging to a segment in which an object of a specific class is recognized is larger than a value of the degree of being an unnecessary object of a point cloud belonging to a segment in which an object of a non-specific class is recognized.

6. The information processing apparatus according to claim 5,
wherein the feature evaluation unit weights the degree of being an unnecessary object according to a likelihood of image recognition in the image recognition processing.

7. The information processing apparatus according to claim 5,
wherein the feature evaluation unit sets the degree of being an unnecessary object of a point cloud belonging to an edge portion of the segment in which the object of the specific class is recognized, such that a point located more externally has a smaller degree of being an unnecessary object.

8. The information processing apparatus according to claim 1,
wherein, regarding point clouds with same evaluation information regarding the feature, the associating unit associates the evaluation information regarding the feature for some points but does not associate the evaluation information regarding the feature for remaining points.

9. The information processing apparatus according to claim 1,
wherein the feature evaluation unit performs image recognition processing as semantic segmentation on the captured image, and
the associating unit associates, as the evaluation information, information indicating a class of an object recognized in the image recognition processing with the point cloud data.

10. The information processing apparatus according to claim 1,
wherein the feature evaluation unit calculates a vegetation evaluation value on a basis of a captured image obtained by a multispectral camera, and
the associating unit associates the vegetation evaluation value as the evaluation information with the point cloud data.

11. The information processing apparatus according to claim 2,
wherein the output processing unit performs the processing of outputting the point cloud data and the evaluation information associated with the point cloud data to a separate external apparatus which is an external apparatus different from the external apparatus and performs point cloud data count adjustment processing on a basis of feature indication information indicating a feature of a point cloud to be extracted.

12. A data structure of data to be output by an information processing apparatus to an external apparatus,
the information processing apparatus including
a point cloud generation unit configured to generate point cloud data indicating a three-dimensional structure of a target area, on a basis of sensing data regarding the target area,
a feature evaluation unit configured to evaluate a feature of a subject within the target area on a basis of a result of analysis of a captured image in which the target area is captured, and
an associating unit configured to associate evaluation information regarding the feature with the point cloud data,
the external apparatus being configured to perform display control of the point cloud data,
the data structure comprising:
the point cloud data; and
the evaluation information associated with the point cloud data,
wherein the external apparatus uses the data structure to perform display control of the point cloud data according to a user operation on a basis of the evaluation information received.

13. A program readable by a computer apparatus, for causing the computer apparatus to execute processing of:
receiving, from an information processing apparatus including a point cloud generation unit configured to generate point cloud data indicating a three-dimensional structure of a target area, on a basis of sensing data regarding the target area, a feature evaluation unit configured to evaluate a feature of a subject within the target area on a basis of a result of analysis of a captured image in which the target area is captured, and an associating unit configured to associate evaluation information regarding the feature with the point cloud data, the point cloud data and the evaluation information associated with the point cloud data; and
performing display control of the point cloud data according to a user operation on a basis of the evaluation information.

14. The program according to claim 13,
wherein the computer apparatus is caused to execute processing of selecting some of multiple points included in the point cloud data on a basis of the evaluation information associated with the point cloud data and the user operation.

15. The program according to claim 14,
wherein the computer apparatus is caused to execute processing of selecting, among the multiple points, a point satisfying a condition related to the evaluation information specified by the user operation.

16. The program according to claim 15,
wherein the evaluation information is a feature evaluation value obtained by quantifying the feature, and
the condition is a condition determined by a threshold for the feature evaluation value.

17. The program according to claim 13,
wherein the computer apparatus is caused to execute processing of outputting, to an apparatus configured to perform count adjustment of the point cloud data, feature indication information which has been confirmed by the user operation and indicates a feature of a point cloud to be extracted.
